(19) United States
(12) Patent Application Publication
(10) Pub. No.: US 2006/0130811 A1
(43) Pub. Date: Jun. 22, 2006

(54) Electronic ignition for aircraft piston engines

(76) Inventors: Thomas C. Carlson, Azle, TX (US); Bradley D. Dement, Azle, TX (US)

Correspondence Address: JENNIFER L. BALES, MOUNTAIN VIEW PLAZA, 1520 EUCLID CIRCLE, LAFAYETTE, CO, 80026-1250, US

(21) Appl. No.: 11/014,201

(22) Filed: Dec. 16, 2004

(51) Int. Cl. F02P 5/15; F02P 15/08

(52) U.S. Cl. 123/406.53; 123/179.5; 123/406.58; 123/638

(57) ABSTRACT

An Electronic Ignition for a piston aircraft engine, which replaces conventional magneto ignitions, includes a precise engine shaft position sensor and incorporates an internal alternator as a backup electrical power source.

### BACKGROUND OF THE INVENTION

1. Field of the Invention

This invention relates to ignition systems. In particular, this invention relates to electronic ignition systems for piston aircraft engines.

2. Description of Related Art

The following references provide useful background for the present invention:

| | | | |
|---|---|---|---|
| 5,513,617 | May 7, 1996 | Bass | 123/595 |
| 6,353,293 | Mar. 5, 2002 | Frus | 315/209R |
| 6,191,536 | Feb. 20, 2001 | Dolmovich | 315/209CD |
| 5,875,763 | Mar. 2, 1999 | Mottier | 123/406.13 |
| 5,754,011 | May 19, 1998 | Frus | 315/209SC |
| 5,630,384 | May 20, 1997 | Mottier | 123/149R |

Original equipment aircraft engine ignition systems incorporate a magneto which consists of a rotating magnet assembly, a magneto coil, a capacitor, a pair of points arranged as a contact breaker and ignition distributor. The outputs of the ignition distributor are connected via wires to spark plugs in the engine cylinders.

The magneto was in use as early as 1908 in early automotive and industrial applications. As late as 1935, some manufacturers were still placing magnetos into cars. But, for all intents and purposes, the end of the magneto in automotive applications came with the end of the Model T Ford in 1927. Piston aircraft engines have incorporated magnetos from the early 1930s. The magneto is still the most widely used ignition source in current production aircraft engines, primarily due to its ability to operate independent of the aircraft electrical system. The magneto is a simple mechanical device which contains parts, such as points distributors and cams, which quickly wear. Engine performance is compromised by the use of a magneto due to the weak spark generated and the fixed spark timing that it provides.

This prior art has been insufficient in reliability and performance. Previous attempts to replace the magneto in aircraft applications were hindered by the requirement of an uninterruptible external power source. Also, the magneto incorporates a mechanical breaker assembly to control the spark timing. This assembly starts to wear and go out of adjustment as soon as it enters service and needs regular inspection, adjustment and eventual replacement if the engine is to operate properly.

Because the magneto must be rotated at a reasonable rpm to generate a magnetic pulse suitable for ignition, a complex mechanical arrangement of springs and cams or an external vibrator and associated electric power source must be incorporated to allow starting. This is an added point of wear and potential failure.

Aircraft magnetos use a fixed advance angle (except during starting) to time the firing of the spark plugs. Although this reduces the mechanical complexity, it means that the advance angle used must be a compromise between low engine speed and idle operation and that of cruise or high power operations.

Many attempts have been made to replace the magneto with more reliable electronic systems in aircraft applications but were hindered by the requirement for an uninterruptible power source.

A need remains in the art for a modern electronic ignition system with enhanced reliability and performance.

### SUMMARY OF THE INVENTION

It is an objective of this invention to overcome the disadvantages of the previous art through replacement of the original design with a modern electronic ignition system.

This invention, which is hereinafter called the “PMAG”, incorporates a brush-less permanent magnet alternator, which is mounted on a shaft directly driven by the engine. Power generated by the aforementioned alternator allows the engine to continue to operate after the loss of all external electrical power. The PMAG also provides greater reliability by eliminating those magneto parts susceptible to wear and increases engine performance by increasing the spark intensity and optimizing spark timing.

Reliability.

The PMAG improves reliability by incorporating a brushless permanent magnet alternator mounted on a shaft directly driven by the engine. Although not required in normal operation, this alternator will provide all required operating power for the ignition in the event of external electrical power loss.

The PMAG uses a non-contacting shaft position encoder to control the spark timing. This assembly has no components subject to mechanical wear, ensuring long life and consistent performance.

Performance

The PMAG utilizes external electrical power during engine starting to provide a powerful spark and uses information from it's internal shaft-encoder to derive engine rotational position and speed in order to fire the engine's spark plugs at the optimum time for starting. This system provides both better starting performance and increased reliability, as there are no mechanical parts to wear.

The PMAG uses a computer-controlled advance curve coupled with engine rotational position and speed information from it's internal shaft-encoder in order to fire the engine's spark plugs at the optimum time for best engine performance in all operational conditions.

### BRIEF DESCRIPTION OF THE DRAWINGS

FIG. 1 is a scale drawing of the “PMAG” electronic ignition of the present invention overlaid on an outline drawing of a typical aircraft magneto.

FIG. 2A is a front view of the PMAG of FIG. 1. FIG. 2B is a cutaway view along section B-B of FIG. 2A. FIG. 2C is a section-view of the PMAG of FIGS. 1-2B with the major components identified.

FIG. 3 is a functional block diagram of the PMAG of FIGS. 1-2C showing the primary components and their interaction.

### DETAILED DESCRIPTION OF THE PREFERRED EMBODIMENTS

Overview:

Mechanical Fit:

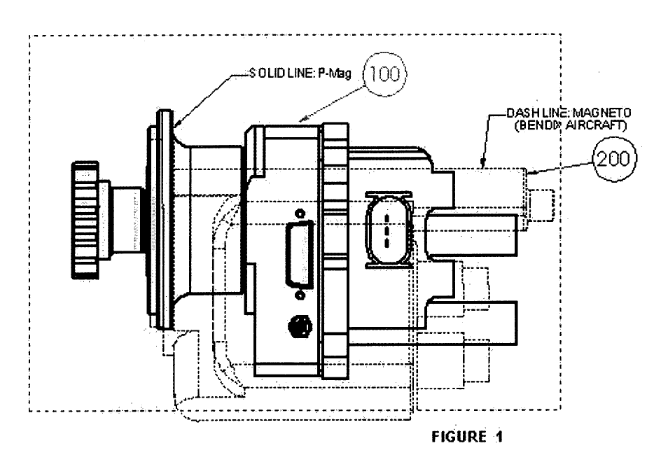

As can be seen from FIG. 1, PMAG 100 that is the subject of this invention ideally fits within the outline of the original equipment magneto 200 and mounts in the same manner to the engine. This allows the PMAG electronic ignition to be substituted in any aircraft application that used the original equipment magneto shown without mechanical modification to the aircraft.

Construction:

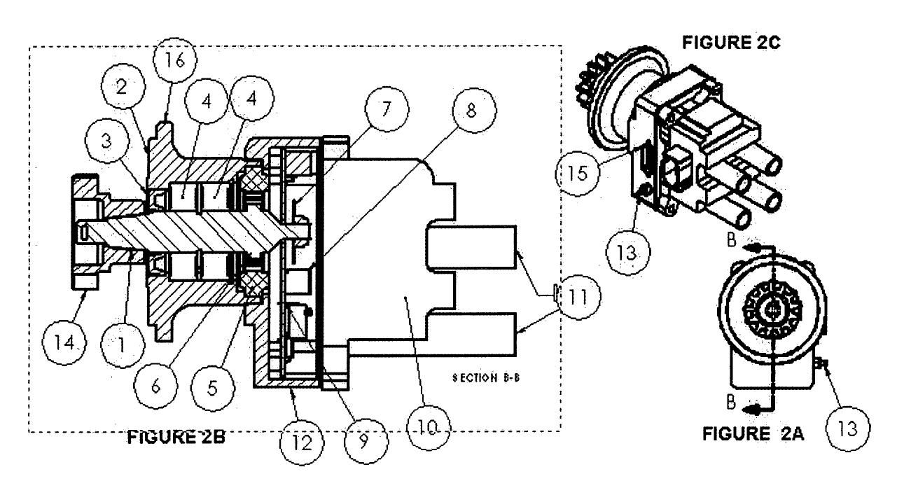

The PMAG shown in FIG. 2 comprises a Shaft 1, Housing with mounting flange 2, Shaft Seal 3, Shaft Support Bearings 4, Alternator Stator 5, Permanent Magnet Alternator Rotor 6, Shaft Position Encoder Disk 7, Shaft Encoder Sensor 8, Electronics Assembly 9, Coil Pack 10, Spark Plug Wire Connections 11 and External Power Connector 12. A gear 14 mounted on the Shaft 1 is supported in the Housing 2 by two Bearings 4 and sealed from engine oil by a Seal 3. A rotary encoder sensor 20 comprises an optical rotary position Encoder Disk 7 and its associated Sensor assembly 8 to provide shaft position information to the Electronics Assembly 9. The ignition Coil Pack 10 is mounted on the back of the Housing 2, and connects to spark plugs via the Spark Plug Wire Connectors 11. The internal alternator Rotor 6 is affixed to the Shaft 1 and rotates within the Stator 5, generating alternating current power for the Electronics Assembly 9. An External Power Connector 12 is connected to the aircraft electrical power for starting purposes.

Operation:

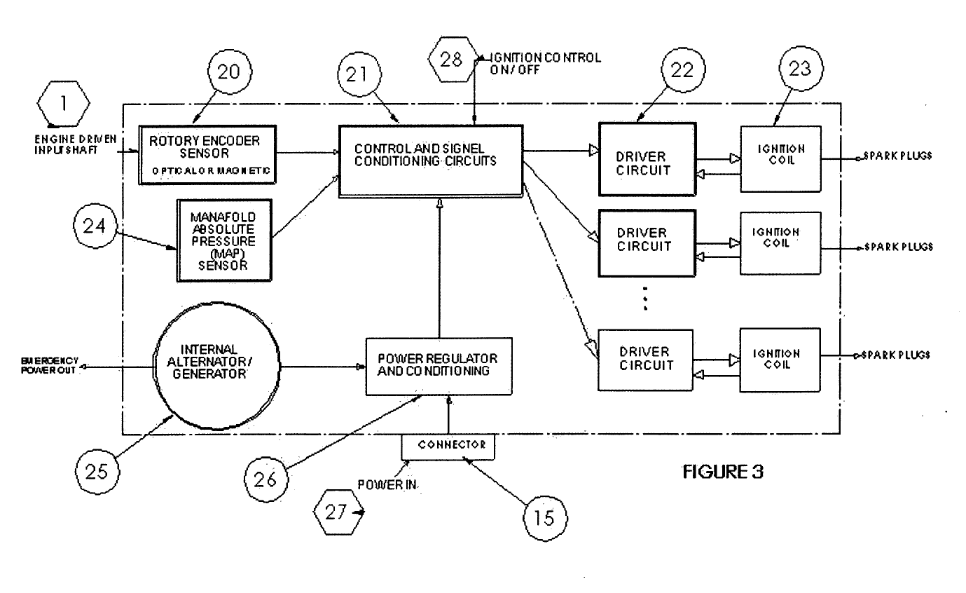

Refer especially to FIG. 2C and FIG. 3.

When electric power is applied to the power terminal 15, current flows through the input filter and regulator circuits 26 providing filtered logic power to the control circuits 21 as well as unfiltered power to the ignition drivers 22. This filtering and regulator circuit 26 includes reversed battery protection, clamping against negative voltage transients, and clamping against over voltage protection. Also, this circuit provides multi-phase rectification of the alternating current provided by the internal brush less alternator 25.

When the ignition enable terminal on connector 15 is released from ground potential the ignition system is enabled and provides drive power at appropriate times to the ignition coils 23 through drivers 22.

Primary timing is derived from the engine driven shaft 1 and rotary position encoder 7, which provides signals precisely indicating TDC (Top Dead Center), rotary position information and rpm. Additional information derived from the Manifold Absolute Pressure sensor 24 is used to modify the advance timing calculated by the control circuits 21.

If electric power 27 is removed from the power terminal of connector 15 during engine operation, the multi-phase brush less alternator 25 supplies electrical power through the power input filter and regulator circuits 26 This action allows continued operation of the ignition in the event of electrical power loss from the aircraft electrical system.

During startup, the use of a shaft position encoder eliminates the possibility of firing the spark before TDC.

During installation, a calibration circuit is activated which provides an audio tone at the index position of the rotary encoder to assist in initial calibration. An alternative embodiment using the magnetic shaft position encoder allows simple calibration by storing the calibration position in the internal memory of the control rather then mechanically aligning the PMAG to the engine.

### DETAILED DISCUSSION

The most preferred embodiment of applicant's ignition system is best illustrated in FIGS. 2A-2C of the drawings and consists of a case 2 which is configured to accommodate the mounting pad on the accessory case of a conventional internal combustion aircraft engine (conventional engine elements are not shown). Said case 2 allows for rotational adjustment when mounted to allow calibration of the ignition during installation.

A drive gear 14 is mounted on a drive shaft 1 supported within two bearing 4 in the case. The drive shaft 1 extends outwardly through an appropriate opening in the gear case and supports a gear 14, which is in driving engagement with an appropriate engine gear (not shown) within the engine accessory case.

An optical rotary encoder 7 is mounted to shaft 1 and provides shaft angle information to sensor 8, the information comprising, for example, 360 pulses per shaft rotation and an index pulse at engine TDC to the control electronics 9 which incorporates a computer component to calculate appropriate ignition firing timing to the ignition driver circuits. Alternatively, other rotary position encoders may by incorporated such as a magnetically driven encoder produced by Austria Microsystems as model AS5040 rotary encoder semiconductor device. This device provides 512 pulses per shaft rotation and an index pulse at engine TDC. The use of a position encoder allows the computer to precisely control the firing time during startup as well as the running phase. Other electronic ignitions based on automotive ignition designs use a single Hall effect sensor to start a timer. The delay of said timer is based on rpm and approximates the correct firing angle of the ignition. The problem with this system is that an aircraft engine shaft rotation speed can vary widely during cranking especially with low battery voltage resulting in the possibility of firing before TDC resulting in a kickback causing engine damage. The PMAG system overcomes this problem by continuously monitoring actual engine crankshaft angle. This provides information to the control circuits to insure that ignition takes place at the approproiate time during start up. During normal engine running, the computer component 21 calculates appropriate ignition firing position based on engine rpm and MAP (Manifold Absolute Pressure) 13 (see FIGS. 2A and 2C). The use of a MAP sensor allows the PMAG to provide higher advanced timing for cruise rpm and power settings while protecting the engine from pre-ignition by reducing the firing advance angle during high power settings (increased manifold pressures).

Note that an alternative to an optical rotary encoder 20 is for elements 7 and 8 to comprise a magnetic angle sensor, which would sense rotation of magnetic elements on shaft 1.

Driver circuits 22 turn on large currents to charge ignition coils 23 in response to control signals from control element 21. In addition, Driver circuits 22 monitor the input current into ignition coils 23, and provide feedback signals to control element 21 to allow closed loop control of the drive currents to the ignition coils. This allows maximum efficiency and lower operating power by stopping the drive current to the ignition coils just before ignition coil core saturation. As the time required to charge the magnetic fields of the ignition coils varies with outside factors such as applied voltage, the start of charge currents must be continuously corrected by the control element 21 to provide precise control of the firing time of the ignition. This design provides consistent spark energy to the spark plugs with variations in input voltage.

The ignition coil assembly 10 consists of two ignition coils 23 for a four-cylinder engine and three ignition coils 23 for a six-cylinder engine. Said coils are potted into a single module mounted to the back of housing 2. Each coil is connected to the spark plug (not shown) via an ignition wire connected to the coil high voltage post 11. Each coil drives two spark plugs using the “wasted spark” technique wherein an ignition spark occurs both at the appropriate time for combustion in one cylinder and during the exhaust phase of the opposing cylinder. This arrangement eliminates the need for a conventional distributor as incorporated in a magneto.

An internal brush less permanent magnet alternator 20 is composed of a magnetic rotor 6 integral with shaft 1 and a stator 5, and provides all required power for correct operation once the engine is started. This is crucial in aircraft piston engines because the engine cannot be allowed to die in case of electrical failure. Magnetic alternator 6, 7 provides a reliable source of power for operating the engine once the shaft is rotating, i.e. anytime after the engine is started.

Aircraft piston engines will generally have at least two P-MAGs 100, so two Magnetic alternators 6, 7 are available to provide power. In one preferred embodiment, one of the Magnetic alternators 6, 7 may be used for other emergency purposes such as powering a radio or lights.

In FIG. 2C, a single connector 15 provides all interconnection for external power and control as well as diagnostic, programming and configuration inputs.

The detailed description of applicant's invention is for illustration purposes only and is by way of example, not by way of limitation.

What is claimed is:

1. A Electronic Ignition (PMAG) intended for supplying ignition to an aircraft piston engine, said Electronic Ignition incorporating (a) an internal brush less alternator to provide all necessary electrical power for the ignition while the engine is running, (b) a rotary position encoder to provide engine crankshaft position information, (c) an electronic circuit to calculate proper ignition timing angle and modes of operation, (d) an ignition driver circuit that provides a feedback for closed loop control of ignition coil drive timing and dwell and (e) an ignition coil or coils to fire spark plugs in the engine.

2. The Electronic Ignition of claim 1 in which said rotary position encoder is an optical position sensor of convenient resolution greater than sixteen pulses per shaft revolution.

3. The Electronic Ignition of claim 1 in which said rotary position encoder is a magnetically derived position sensor of convenient resolution greater than sixteen pulses per shaft revolution.

4. The Electronic Ignition of claim 1 in which the calculation of proper ignition timing is performed by a computer component.

5. The Electronic Ignition of claim 1 in which calculation of firing angle is based on actual shaft angle rather then timing from a fixed event.

6. The Electronic Ignition of claim 1 which incorporates an internal indicator device to assist in initial installation and calibration is incorporated.

7. The Electronic Ignition of claim 1, which incorporates additional circuitry and software, to prevent improperly timed ignition events during startup.

8. The Electronic Ignition of claim 1 in which the entire device is contained in a unit, which mounts to the engine in the same manner as a conventional magneto.

9. The Electronic Ignition of claim 1 in which multiple spark events are produced under computer control during startup to assist in engine starting.

10. The Electronic Ignition of claim 7 which incorporates multiple coils, each coil directly connected to and firing two spark plugs.

11. The Electronic Ignition of claim 7, which incorporates a single coil, said coil firing multiple spark plugs via a rotary spark distributor.

12. The Electronic Ignition of claim 7 which fires external coils, said coils directly connected to and firing individual spark plugs.

13. The Electronic Ignition of claim 1 in which the entire unit is contained in a unit that mounts to the engine in the same manner as a Bendix dual-magneto.

14. The Electronic Ignition of claim 13 which incorporates multiple coils, each coil directly connected to and firing two spark plugs.

15. The Electronic Ignition of claim 13 which incorporates a single coil, said coil firing multiple spark plugs via a rotary spark distributor.

16. The Electronic Ignition of claim 13 which fires external coils, said coils directly connected to and firing individual spark plugs.
